(19) United States
(12) Patent Application Publication
(10) Pub. No.: US 2016/0107168 A1
(43) Pub. Date: Apr. 21, 2016

(54) AGGREGATE BREAKER AND SORTER WITH MODIFIED GRIZZLIES

(71) Applicant: Imperial Technologies, Inc., Canton, OH (US)

(72) Inventor: Ronald H. Tschantz, Malvern, OH (US)

(73) Assignee: IMPERIAL TECHNOLOGIES, INC.

(21) Appl. No.: 14/518,832

(22) Filed: Oct. 20, 2014

(51) Int. Cl. B02C 23/14; B02C 19/00; B07B 1/04; B02C 13/04; B07B 15/00; B07B 1/12

(52) U.S. Cl. CPC B02C 23/14; B07B 15/00; B07B 1/12; B07B 1/04; B02C 13/04; B02C 19/0012

(57) ABSTRACT

An apparatus for sorting a material such as coal from rock is presented. The system includes a housing, a grizzly, a flail, an impact grate and lower grate(s). The grizzly allows small pieces of material to pass through the grizzly. The grizzly includes elongated grizzly bars that are wider at their upper ends than lower ends so that tapered openings formed between the grizzly bars are wider at the lower ends than the upper ends. The flail has paddles that spin and break material not passing through the grizzly. The impact grate receives and further breaks material hit by the flail. Lower grate(s) allow material of a predetermined size to pass through them to be collected for further use while at the same time not allowing material bigger than the predetermined size to past through them so that this unwanted material can be disposed of.

### BACKGROUND OF THE INVENTION

1. Field of Invention

The current invention relates generally to apparatus, systems and devices for processing a variety of materials such as coal. More particularly, the apparatus, systems and devices relate to separating materials from rock. Specifically, the apparatus, systems and devices provide for separating coal from rock using spinning flails, impact grids, and sizing grizzlies.

2. Description of Related Art

It is often necessary upon removing coal from a mine or strip pit to further process the coal before it is used. This can be done by breaking the coal and sorting it into certain sizes and removing rocks, shale or other impurities therefrom. Depending upon the final use for which the coal is intended and the type and hardness of the particular coal being mined, the coal is broken and separated into predetermined size particles. Two inch sized particles are a common size for many burning applications.

This crushing and splitting of the coal has been performed by various types of equipment such as a rotary roll crusher in which coal passes between and is crushed by counter-rotating rolls and then discharged into a chute or conveyor for subsequent shipment. Such roll crushers have the disadvantage in that everything including coal and other impurities must go through the crusher rolls and everything is broken into smaller particles. It is preferable that impurities be removed, not crushed, and transported with the coal. Another type of prior art crusher or breaker is a rotary breaker which consists of a large hollow rotating drum having a plurality of holes and baffles inside which will break the coal as it is tumbled within the drum.

Although these breakers perform satisfactorily, they require a considerable amount of energy for rotating the drum or crusher rolls. Furthermore, it is difficult to change the setting for the size of coal desired. Also, it is difficult to confirm the breaking force with the hardness of the particular seam of coal being broken by the equipment.

These known crushers usually are located at a coal wash plant which may be located some distance from the mine or pit, requiring the coal together with the impurities to be transported to the processing site with the refuse or removed impurities being returned to the original site for disposal. All of these hauling and processing operations increase the cost of processing the coal.

Several types of coal breakers use rotors which propel the coal against impact surfaces for breaking the coal into smaller particles. Although these breakers perform satisfactorily, they require a relatively large motor and increased power because of the heavy structural members since the rotor changes the direction of the coal or material being broken after being struck with the rotor blades. Also, the rotor blades perform some of the crushing or breaking action instead of merely propelling the coal particles and increasing the speed thereof for impact crushing against a surface. These types of rotary crushers also have the disadvantage of not removing the coal particles as soon as possible after being reduced to the desired size. The coal and sized particles will remain in the crusher for a longer period of time than necessary resulting in the particles being further reduced in size which results in fines or dust being created which may be too small for use and sale.

Many of these problems have been eliminated by the coal breaker and sorter construction of U.S. Pat. No. 4,592,516.

It is also desirable to properly size and separate the coal particles of a desired size from the aggregate stream as soon as possible so they are not accelerated into contact with impact grates which further reduces their size to smaller than desired and creates undesirable fines.

Therefore, there is a need for an improved coal breaker and sorter having modified grizzlies which eliminates many of the above problems and satisfies needs existing in the art.

### SUMMARY

In one aspect, the invention may provide an aggregate breaker and sorter comprising: a housing; an inclined grizzly assembly inside the housing to allow material of a certain size to pass through the grizzly assembly; wherein the grizzly assembly further comprises: a plurality of elongated spaced grizzly bars having upper and lower ends forming tapered openings between adjacent grizzly bars, with said openings being wider at the lower ends than at the upper ends; a flail assembly with a plurality of paddles inside the housing for moving and accelerating the material as it moves along the grizzly assembly; an impact grate assembly inside the housing to receive and break material moved by the flail assembly; and at least one lower grate to allow material of a predetermined size to pass through the at least one lower grate to be transported to a wanted material location, and wherein the at least one lower grate does not allow material larger than the predetermined size to pass through the least one lower grate so that this material can be discarded.

In another aspect, the invention may provide a grizzly assembly for mounting in an aggregate breaker and sorter comprising: a plurality of elongated grizzly bars having first and second ends forming elongated tapered openings between adjacent grizzly bars, with said openings being smaller at the first end than at the second end.

### BRIEF DESCRIPTION OF SEVERAL VIEWS OF THE DRAWINGS

One or more example embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example interior view of an aggregate accelerator embodiment of the present invention;

FIG. 2 illustrates an end view of a prior art flail assembly;

FIG. 3 illustrates an example perspective view of an embodiment of a flail assembly of the present invention;

FIG. 4 is an end view of the flail assembly illustrated in FIG. 3;

FIG. 5 is a view looking in the direction of Arrows 5-5, FIG. 4;

FIG. 6 illustrates an example perspective view of an embodiment of a scalping grizzly of the aggregate accelerator;

FIG. 7 is a top view of the scalping grizzly of FIG. 6;

FIG. 8 is an enlarged detailed view of an adjustment mechanism shown encircled in FIG. 1;

FIG. 9 illustrates an example interior view of the embodiment of the aggregate accelerator of FIG. 1 while it is in operation;

FIGS. 10A-B illustrate fragmentary top views of the scalping grizzly shown in FIGS. 6 and 7 while material is sliding across it; and

FIGS. 11A-C illustrate end views of the scalping grizzly while material is dropped through it.

Similar numbers refer to similar parts throughout the drawings.

### DETAILED DESCRIPTION

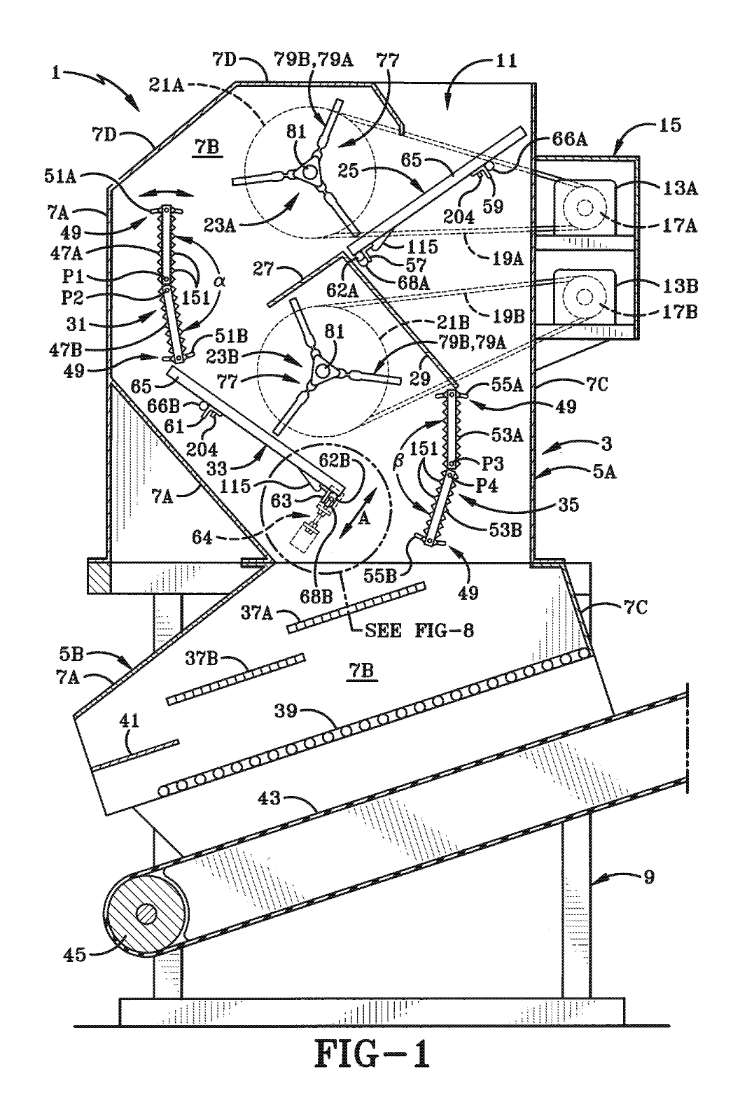

FIG. 1 illustrates an example embodiment of an aggregate accelerator which is illustrated in a coal breaker and sorter 1. Note that while the example embodiment is described with respect to a coal breaker and sorter 1, it can also include breakers and sorters for other materials that generally shatter when broken, such as sulfur, salt, and the like. Some of the improvements made in the coal breaker and sorter 1 over the prior art include flails that don't break as often and when they do break they are easier and cheaper to replace. A further improvement is that the breaker and sorter 1 includes redesigned grizzlies that do not clog as much as prior art grizzlies. Also, its grizzly(s) and impact grid(s) are adjustable so that the coal breaker and sorter 1 can be “tuned” to remove more rock and dirt from one type of coal/rock/dirt combination from a particular seam of coal and then later “retuned” for a different coal/rock/dirt combination from a different seam of coal, for example, at different coal mining locations.

The coal breaker and sorter 1 is illustrated in FIG. 1 with its left side walls removed so that the interior components of coal breaker and sorter 1 are easily seen. The coal breaker and sorter 1 includes a housing 3 that has two halves including an upper housing 5A and a lower housing 5B. In addition to the open left walls of FIG. 1, the housing 3 includes front walls 7A, right walls 7B and back walls 7C as well as top walls 7D. The housing left walls and other walls 7A-D are mounted on a support structure 9 that may be formed out of metal I-beams or other ridged components as understood by those of ordinary skill in the art. In the example embodiment, the walls 7A-D can be formed out of ⅜ inch metal but other sizes of metal and other materials can be used. An opening 11 is formed at in the top wall 7D to allow raw material to enter at the top end of the coal breaker and sorter 1.

The coal breaker and sorter 1 further includes a pair of motors 13A-B installed in a motor housing 15 located adjacent the back wall 7C of the upper housing 5A and connected to motor sheaves 17A-B. The motor sheaves 17A-B are each respectively connected to belts 19A-B that are each connected to flail (rotor) sheaves 21A-B as illustrated. Each of the flail sheaves 21A-B is connected to a flail assembly 23A-B. Flail assembly 23A is an upper flail assembly 23A and is located above lower flail assembly 23B.

A first feed scalping grizzly 25 extends downward from the opening 11 toward a bottom end of flail assembly 23A. A first grizzly feed chute 27 extends from a bottom end of the first feed grizzly 25 and extends parallel to the first scalping grizzly 25 as illustrated in FIG. 1. A first fines chute 29 extends downward and forms about a 90 degree angle with respect to the upper scalping grizzly 25.

An upper impact grate assembly 31 is located near the front wall 7A of the upper housing 5A. A lower scalping grizzly 33 extends from a bottom end of the upper impact assembly 31 and is pointed downward toward a bottom end of a lower impact grate assembly 35. One or more lower grates 37A-B can be located in an upper portion of lower housing 5B. A lower final sorting grate 39 is located near the bottom of the lower housing 5B and an output chute 41 is located near a lower front side of the lower housing 5B. A conveyer belt 43 can be placed below the lower final sorting grate 39 and around a conveyer wheel 45.

The upper impact grate assembly 31 can have two halves 47A-B where each half can be mounted in the upper housing 5A so that each half has a pivot at pivot points P1-2. Adjustment mechanisms 49 can be used to rotate each half 47A-B of the upper impact grate assembly 31 within slots 51A-B cut in the right and left walls 7B to create a desired angle, α, between the two halves 47A-B. When the desired position is reached, the adjustment mechanisms 49 can lock the two halves 47A-B in place. The adjustment mechanisms 49 can be bolts or other device as understood by those with ordinary skill in the art.

Similarly, the lower impact grate assembly 35 can have two halves 53A-B where each half can be mounted in the upper housing 5A so that each half has a pivot at pivot points P3-4. Adjustment mechanisms 49 can be used to rotate each half 53A-B of the lower impact grate assembly 35 within slots 55A-B cut in the right and left walls 7B to create a desired angle, β, between the two halves 53A-B. When the desired position is reached, the adjustment mechanisms 49 can lock the two halves 53A-B in place.

The upper grizzly 25 includes cross-member devices 57, 59. The lower grizzly 33 has similar cross-member devices 61, 63. As discussed in detail below the cross-member devices 57, 59 are used to connect elongated grizzly bars 65 together into panels. The cross-member devices 57, 59, 61, 63 can be formed out of metal bars, L-shaped metal bars or a different type of metal bar or out of different material. The lower grizzly 33 is illustrated with an adjustment mechanism 64 and with its upper cross-member member 61 attached to a pivotal rod 66. The adjustment mechanism 64 allows the position of the lower grizzly 33 to be moved to a desired position as indicated by arrow A. In other embodiments, the upper grizzly 25 could also include a similar adjustment device 64.

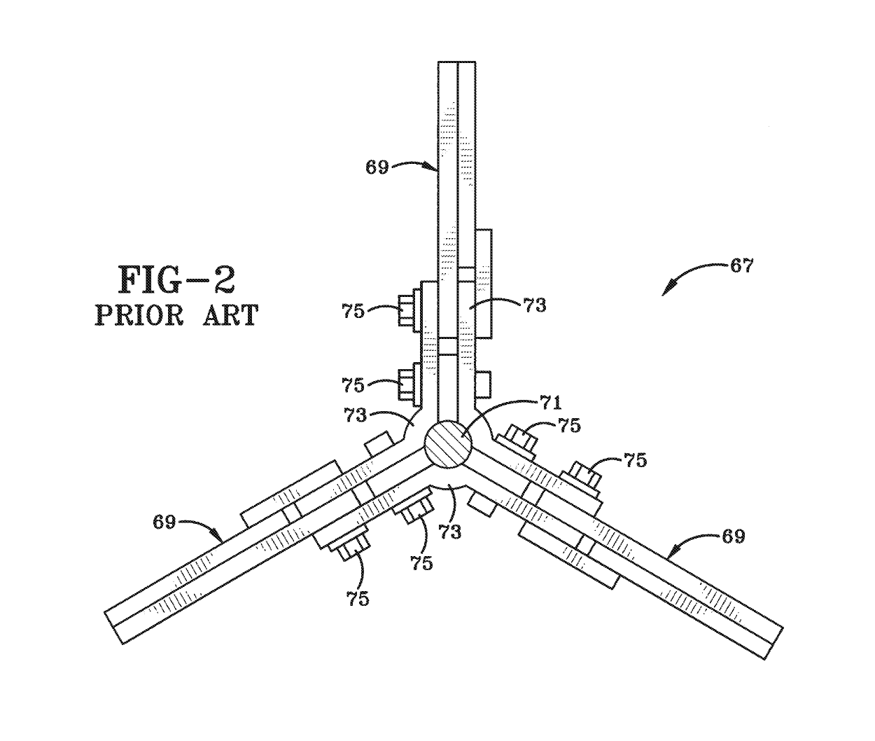

FIG. 2 illustrates a prior art flail assembly 67. It has three paddles 69 rigidly connected to a central axle 71. The paddles 69 are connected to the axle 71 with rigid connector devices 73 using bolts 75. When assembled, the prior art flail assembly 67 was entirely rigid. This presented several problems. When it failed in operation, it failed badly because when one paddle broke away from the prior art flail assembly 67 or was partly broken, the flail assembly 67 was out of balance and the other two paddles 69 may then also break soon. Also, when it broke, it took a long time to replace a single paddle 69 due to the number of bolts needing to be replaced and the number of pieces needing bolted together. Alternatively, the entire flail assembly 67 might need to be replaced.

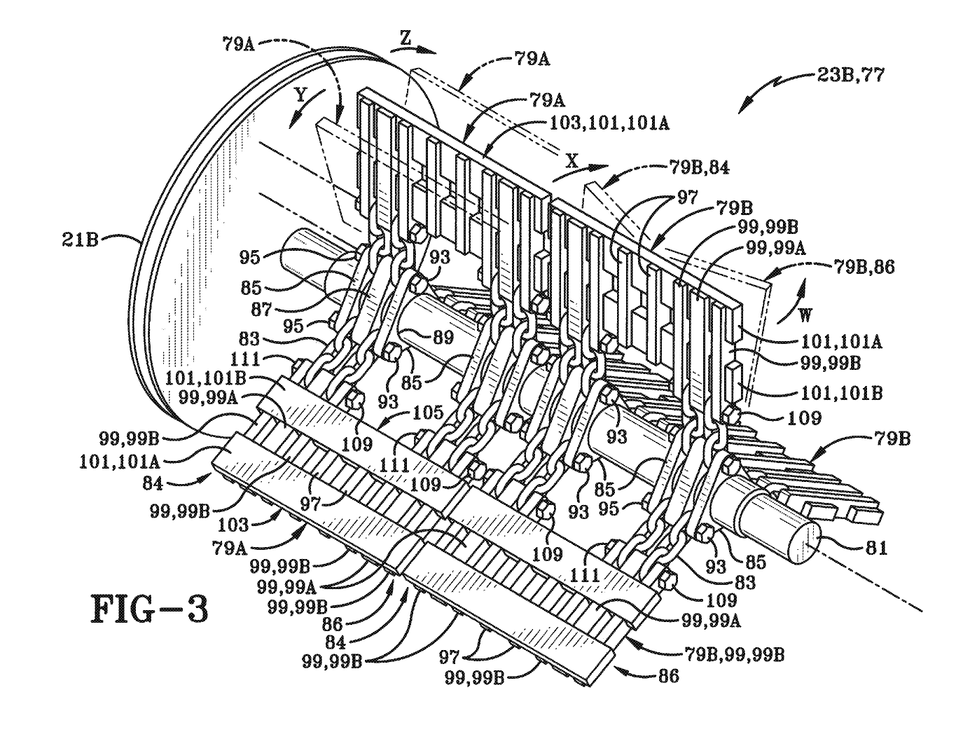

FIGS. 3-5 illustrated the example embodiment of an improved flail assembly 77. Rather than having one paddle spanning the entire length of the flail assembly 77 like the prior art assembly 67 (FIG. 2), the example embodiment has two separate flails or paddles 79A-B. The example embodiment flail assembly 77 has three of each of these separate flails or paddles 79A-B equally spaced 120 degrees apart from each other around a cylinder 81 and connected to the cylinder 81 with chains 83. Of course, in other embodiments more or less than three paddles pairs 79A-B can be connected around the cylinder 81. These chains 83 allow the paddles 79A-B flexibility of movement so that they are less prone to break as described further below when discussing the operation of the coal breaker and sorter 1. The paddles 79A-B are shown connected to the cylinder 81 with chains, however, in other embodiments the paddles 79A-B can be connected to the cylinder 81 in other ways preferably allowing the paddles 79A-B some freedom of movement independent of the cylinder 81. The central cylinder 81 may be part of an axle that is connected to the sheaves 21A-B or in some embodiments it can be separate from that axle and can be slid and locked onto that axle.

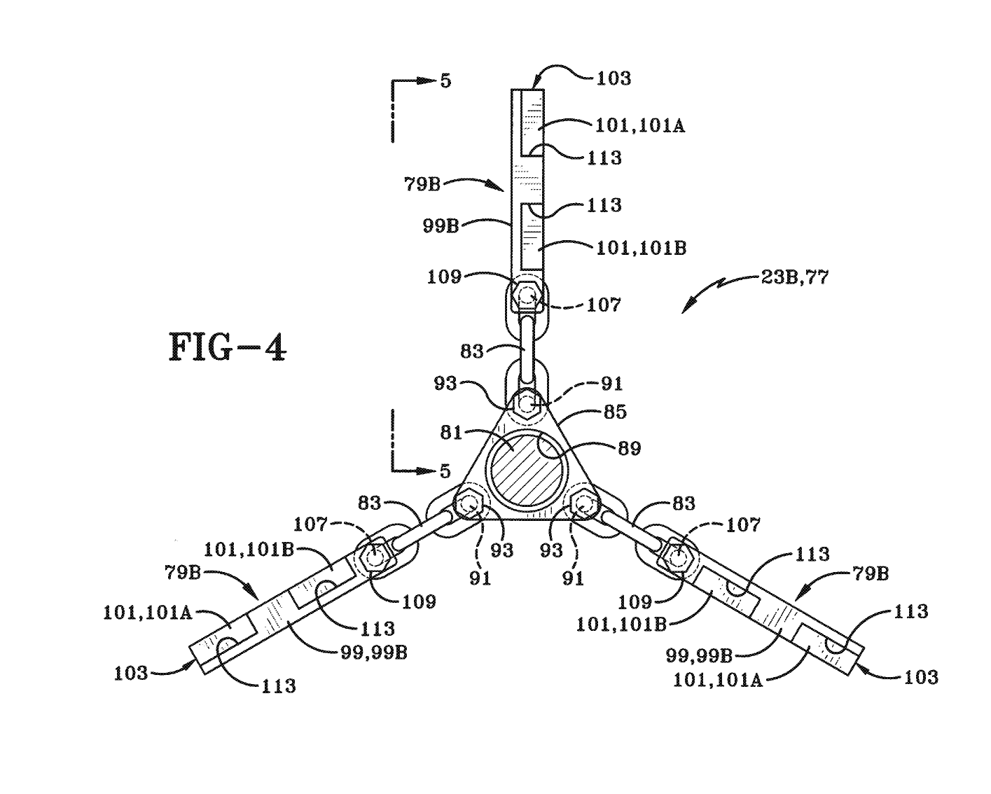

Each paddle 79A-B has a left end 84 and a right end 86. The left end 84 of each paddle 79A-B is connected two outer brackets 85 and one inner bracket 87. Each of these brackets 85, 87 are rigidly connected to the cylinder 81. In the example embodiment, these brackets 85, 87 are generally equilateral shaped triangles with rounded points or vertices but they can be other shapes. The inner bracket 87, in the example embodiment is thicker than the two outer brackets 85. Each Bracket 85, 87 has a central hole 89 (best seen in FIG. 4) allowing it to be slid onto the cylinder 81 and then rigidly attached to it by welding or in another way. The pointed ends or vertices of each of the outer brackets 85 and the inner brackets 87 have holes 91 allowing a bolt 93 to pass through them. Bolts 93 and lock nuts 95 can then be used to connect the chains 83 to the outer brackets 85 and the inner brackets 87. Using two outer brackets 85 and a central inner bracket 87 allows two chains 83 to be connected to the left end 84 of each bracket as illustrated. Similar to what was discussed above, chains 83 extending from the right end 86 of each paddle 79A-B are connected to the cylinder 81 in a similar way that the left end 84 was connected to the cylinder 81.

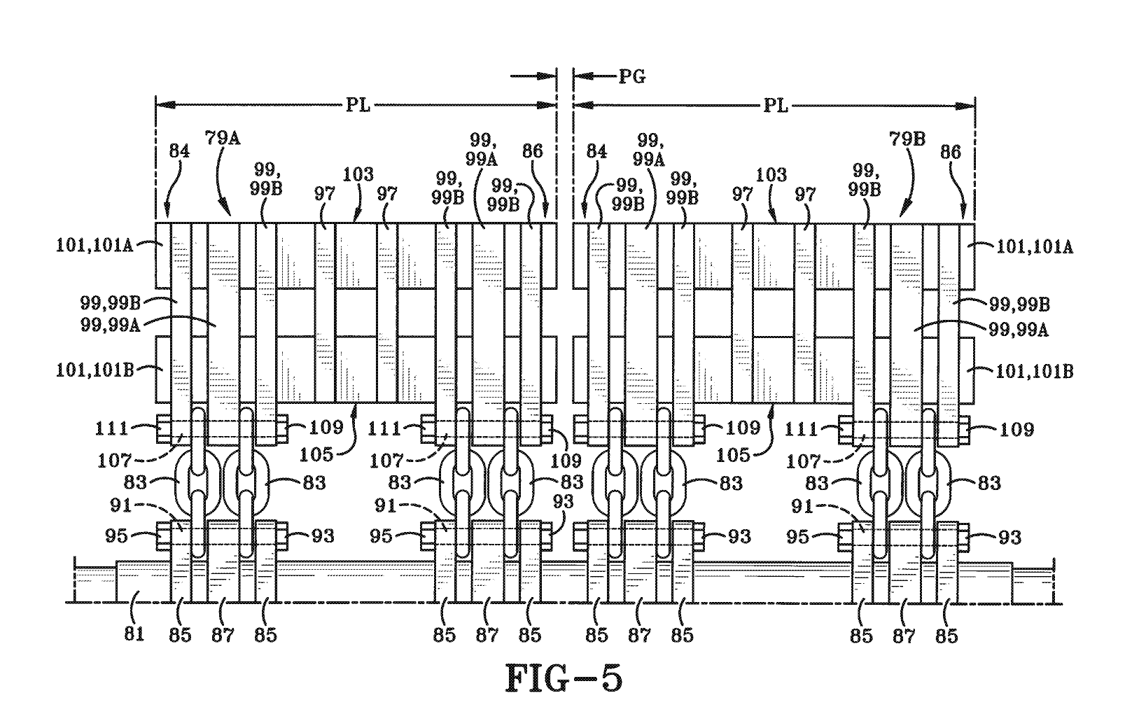

The paddles 79A-B are constructed with short bars 97, long bars 99 and plate bars 101. In the example embodiment these bars are made with metal that is preferably a strong/heavy steel. As probably best seen in FIG. 5, these bars 97, 99, 100 all extend from an outer edge 103 of a paddle 79 A-B over an outer plate bar 101A and across an inner plate bar 101B. In the example embodiment, all of these bars 97, 99, 100 extend at least to an inner edge 105 of the paddle 79A-B. In the example embodiment, the bars 97, 99, 100 are rectangular in shape. As illustrated and best seen in FIG. 5, the long bars 99 extend beyond the inner edge 105 of the paddles 79A-B.

The long bars 99 include thick bars 99A and thin bars 99B. One thick bar 99A has two thin bars 99B place on both sides of it at the left end 84 of each paddle 79A-B and also at each right end 86 of each paddle 79A-B. Holes 107 (FIG. 4) formed in the long bars 99 allow bolts 109 to pass through the chains 83 and long bars 99. Lock nuts 111 secure the bolts 107 to the chains 83. In the example embodiment, each of the short bars 97 and long bars 99 have notches 113 formed in them (FIG. 4). The plate bars 101 are located in the notches 113 and are rigidly welded or attached to the other bars in another way.

Some of the physical dimensions of the example embodiment will now be mentioned, however, in other configurations of the example embodiment, one or more other dimensions could be used. As indicated in FIG. 5, each paddle 79A-B has a length PL of about 1 foot, 7 inches wide and the two paddles are separated with a paddle gap PG of about ¾ of an inch. The bolts 95, 109 are about 6 inches by ¾ of an inch. Nuts 95, 111 are about ¾ of an inch lock-nuts.

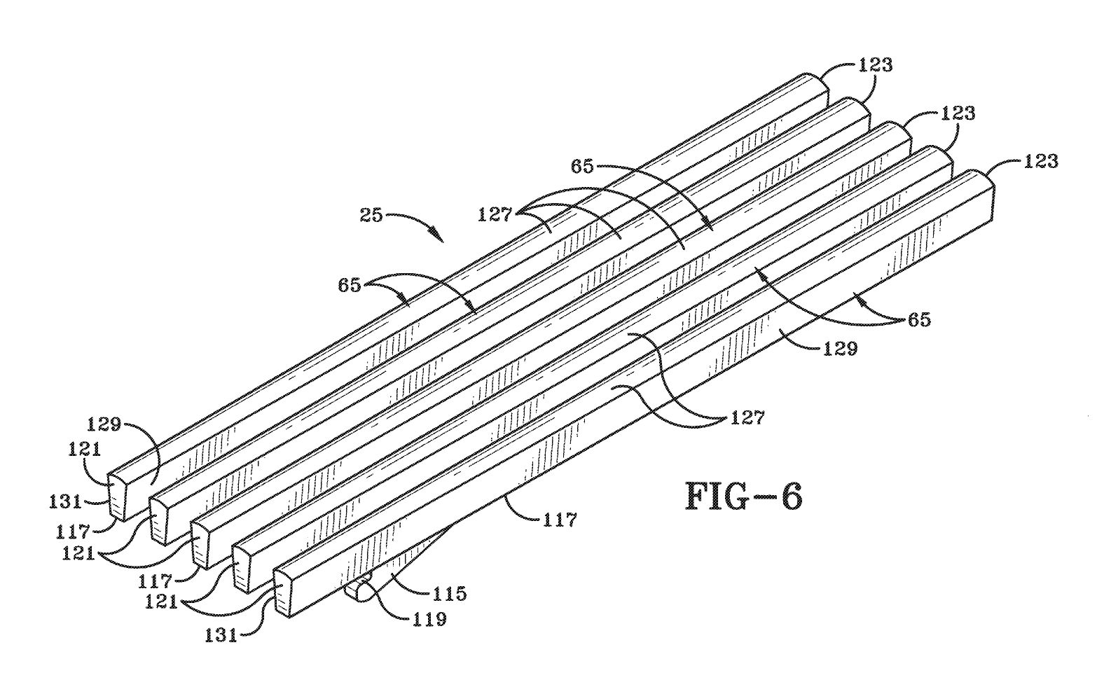

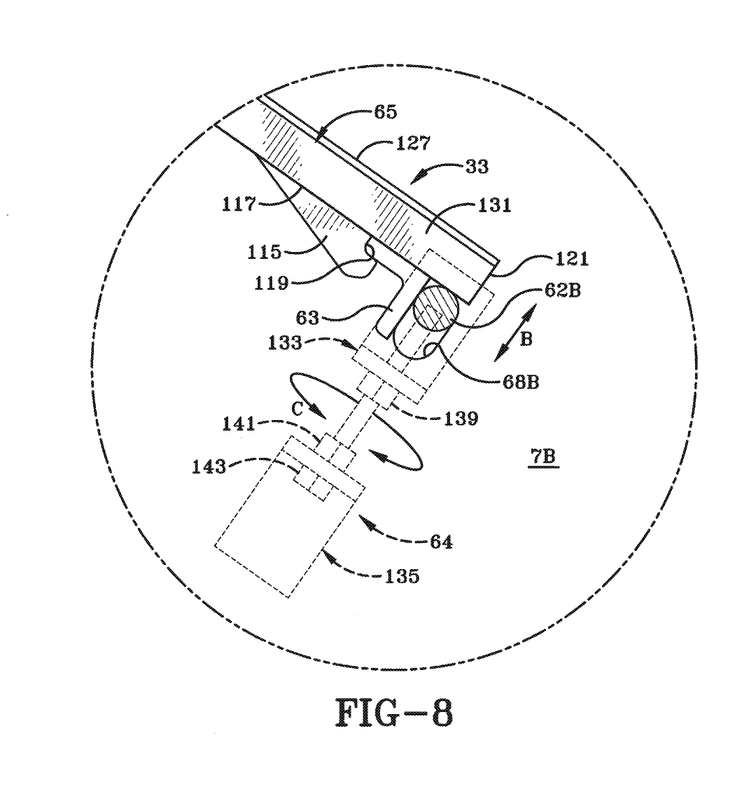

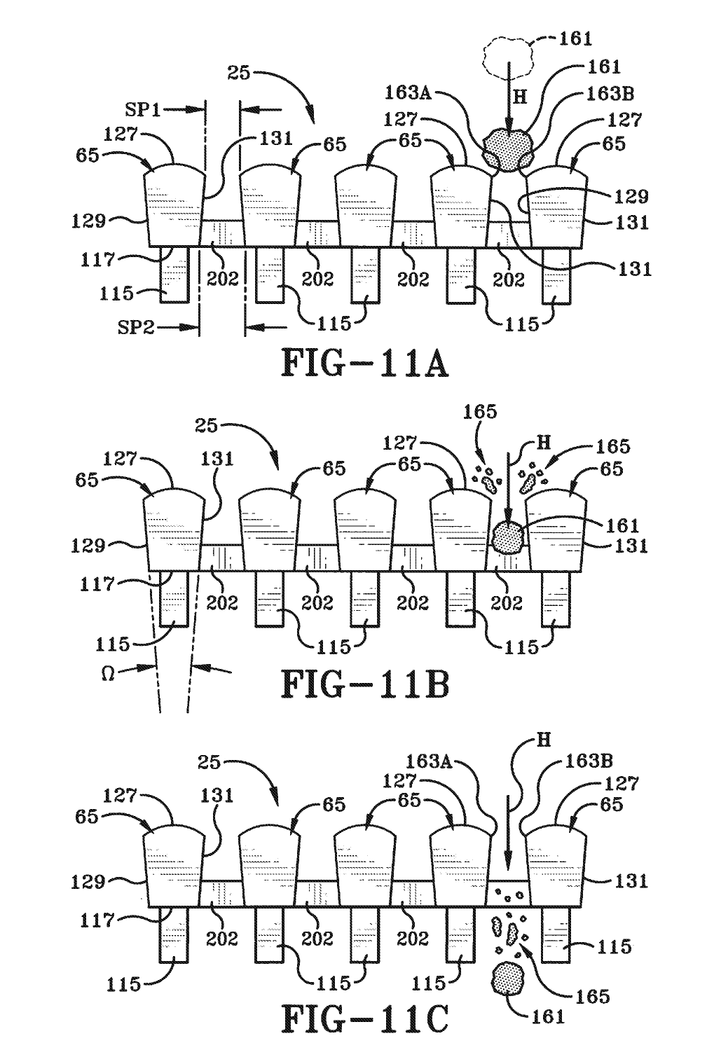

The upper scalping grizzly 25 will be further described with reference to FIGS. 6-8; however, this description similarly applies to the lower scalping grizzly 33. The upper grizzly 25 includes five grizzly bars 65. However, in other configurations it can have fewer or more grizzly bars 65. Each of these bars 65 can include a beveled protrusion 115 (FIGS. 6 and 11A-C) that is somewhat wedge shaped extending downward from a bottom end 117 of the grizzly bars 65. The beveled protrusion 115 forms a gap 119 between the grizzly bar 65 and a lower end of the beveled protrusion 115. As best seen in FIG. 8 this gap 119 can be used to properly align the grizzly bars 65 so that left ends 121 are aligned when the scalping grizzly 25 is assembled.

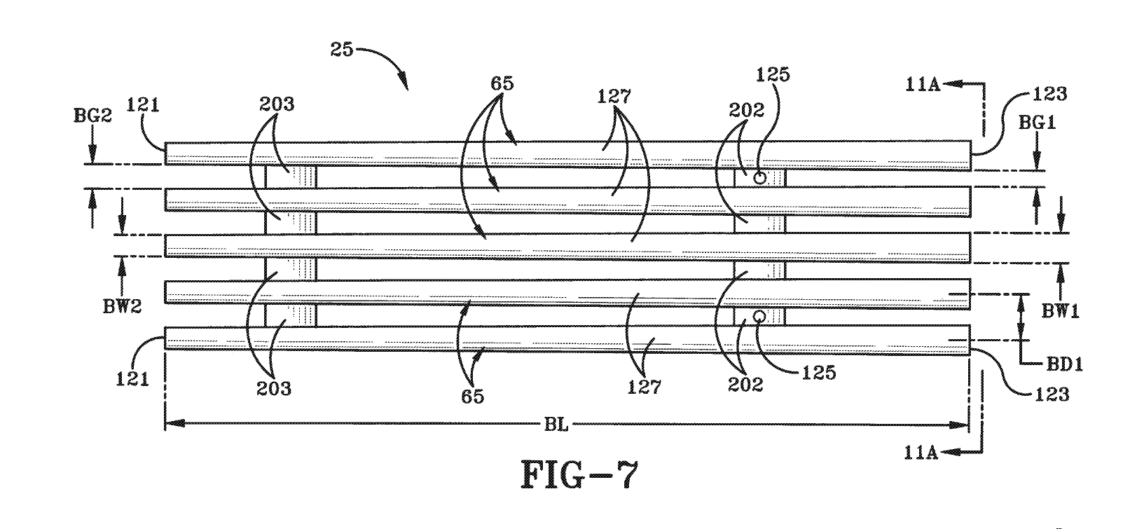

FIGS. 6-8 illustrate an example single scalping grizzly 25. However, in the example embodiment, three of these scalping grizzlies 25 would be connected together side-by-side by connecting them together to cross-members (not illustrated) that span the five grizzly bars 65 near the right or upper ends 123 and left or lower ends 121 of the three scalping grizzlies 25. For example, clevis pin wedges can be passed through holes 125 holes (FIG. 7) and into an upper cross-member that connects all three scalping grizzlies 25 together. Similarly, a bottom cross-member that spans all three grizzlies 25 can be fastened to the bottom cross-member devices 63 (e.g., angle iron) of each of the three grizzlies 25 to be connected together. Of course, three scalping grizzlies 25 can be connected together in other ways as understood by those of ordinary skill in this art.

As best seen in FIG. 11A each of the grizzly bars 65 has, in the example embodiment, a rounded preferably convex top surface 127 and flat planar tapered side surfaces 129, 131 that taper downwardly inwardly toward each other toward a flat bottom surface 133. The side surfaces 129, 131 form an angle of Ω with respect to each other. For example, Ω can in the example embodiment be between about 3 degrees and 45 degrees. The top surface 127 can be an arc of a circle or another kind of curved surface. The angle Ω causes an upper space SP1 to be less than a lower space SP2

As is best seen in FIG. 7, the grizzly bars 65 are each tapered along their length. The right or upper ends 123 in the example embodiment have a bar width BW1 of 1¾ of an inch wide and are tapered down to a bar width BW2 of 1¼ of an inch at their left or lower ends 121. The bar gap BG1 between grizzly bars 65 is 1 inch at the right ends 123 and the bar gap BG2 is 1½ inches at the left or lower ends 121. Therefore, the bar distance BD1 between the centerlines of two adjacent bars is 2¾ inches. The grizzly bars 65 are generally between two to four feet in bar length BL. Even though some preferred dimensions and illustrations are provided, in other configurations differing dimensions and illustrations can be used.

As mentioned above, the lower scalping grizzly 33 has an adjustment device 64. As illustrated in FIG. 8, the adjustment device 64 can be used to move the lower scalping grizzly 33 in the directions of arrow B which is similar to arrow A in FIG. 1. Although any appropriate adjustment device can be used, the adjustment device 64 illustrated in FIG. 8 is a sleeve and jack bolt/screw type of adjustment device. It includes an upper assembly 133 and lower assembly 135. An elongated bolt 137 is connected between the upper and lower assemblies 133, 135 by nuts 139, 141 and 143 as illustrated. When the elongated threaded rod 137 is rotated in either of the two directions of arrow C, the lower scalping grizzly will be moved either up or down as illustrated by the directions of arrow B.

Having described the coal breaker and sorter 1, its use and operation will now be described. One feature of the coal breaker and sorter 1 is that it can be “tuned” for a particular coal/rock/dirt combination from a particular coal deposit to extract a maximum amount of coal of an optimum size from that deposit. “Tuning” is possible because coal is compressed bio-material that tends to shatter when struck while different rocks tend to break and not shatter. By finding optimal settings/positions of various components of the coal breaker and sorter 1 it is possible to more efficiently separate more coal from unwanted rock/dirt based on the way these different materials break apart. Traditionally, prior art accelerators pretty much had one setting for breaking/separating coal from rock and soil. The “tuning” can be done before separating coal if the properties of a particular coal/rock/dirt combination to be processed are known. Alternatively, the tuning can be performed while separating coal and it can later be tweaked while in operation to adjust the proper settings needed for maximum productive coal separation.

The coal breaker and sorter 1 can be tuned or adjusted by selecting optimal positions for the upper grizzly 25 and the lower grizzly 33 by adjusting their adjustment devices 64. These adjustments determine how much material passes thought these scalping grizzlies 25, 33 before being struck by their respective rotor/flail assemblies 23A-B. Further tuning/adjusting can be accomplished by adjusting, as discussed above, the angle, α, between both halves 47A-B of the upper impact grate assembly 31 as well as the angle, β, of both halves 53A-B of the lower impact grate assembly 35. Adjusting the impact grate assemblies 31, 35 in this way controls how material being processed travels upon hitting the impact grate assemblies 31, 35. For example, material hitting the impact grate assemblies 31, 35 can be controlled so that it does not fly in an upward direction so that it cannot be hit a second time by the same flail/rotor assembly 23A-B. Additionally, the speed of the flail/rotor assemblies 23A-B can also be turned to a specific material being processed. Typically the upper flail/rotor assembly 23A is run at about 400 rotations per minute (rpm) and the lower flail rotor assembly 23B is run between +20 and −50 rpm of the upper flail/rotor assembly 23A.

Before beginning processing material the motors 13A-B are started so that their paddles 69 begin to spin so that a centrifugal force pushes them outward because they are attached to chains 83. Preferably, additional material to be processed should have been earlier prescreened so that it is small enough to be handled by the coal breaker and sorter 1. For example, material no bigger than 10×10 inches should be processed by the coal breaker and sorter 1.

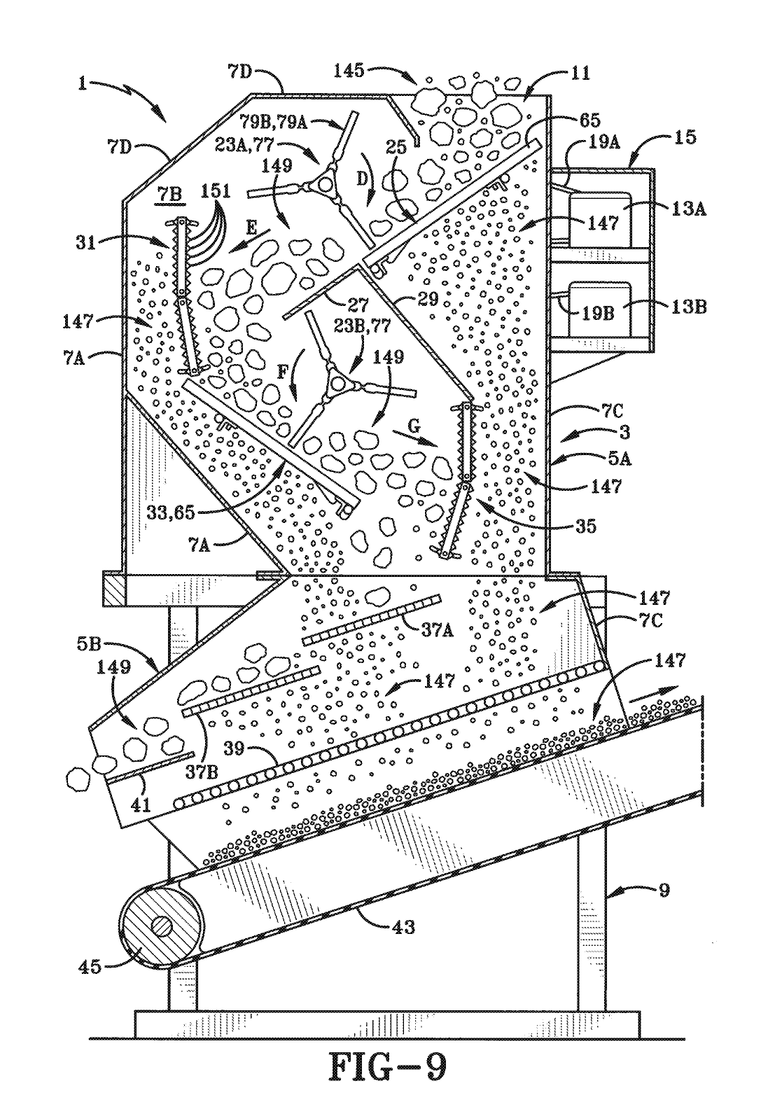

As best illustrated in FIG. 9, the material to be processed 145 is dropped into the upper opening 11 of the coal breaker and sorter 1. This material 145 lands on the upper scalping grizzly 25 where small fines material 147 passes through it. Fines 147 are generally material of about ½ to 1 inch in diameter in size, but the can be other sizes. Larger coal material and rock 149 that does not pass through the upper grizzly 25 but rather slides downward over the first grizzly chute 29 toward the upper flail/rotor assembly 23A where it is struck by the upper flail assembly's 23A paddles 79A-B moving in the direction of arrow D. This rapidly propels that larger coal material and rock 149 in the direction of arrow E toward the upper impact grate assembly 31 where pointed projections 151 on an outer surface of the grate assembly 31 and other structures on the grate assembly 31 cause the larger coal material 149 to break into further fines 147 that pass through the grate assembly 31 as illustrated. In general, the upper and lower impact grates 31, 35 have about 1 inch square openings allowing for fines 149 to pass through but in other configurations the opening can be other/different sizes. Notice that the two halves 47A-B of the upper impact grate assembly 31 are angled so that material and rock 149 are not tossed upward and so that they are not tossed toward the upper flail rotor assembly 23A and re-struck. Fines 147 that make it through the upper grate assembly 23A now pass downward near the front internal side 7A of the coal breaker and sorter 1.

Because the paddles 79A-B are connected by chains 83 there is some freedom of movement (as best seen in FIG. 3) of each paddle 79A-B that is independent of the other paddle. As illustrated in FIG. 3, if a large piece of material is hit by paddle 79B on its left end 84, it will be defected in the direction of arrow W rather than breaking like the prior art paddles. Similarly, if a large piece of material is hit by paddle 79B on its right end 86, it will be defected in the direction of arrow X. If a rather large amount of material is evenly struck near the center of paddle 79A or across its length then this paddle can be momentarily deflected backward in the direction arrow Y rather than breaking like prior art flail assemblies. Paddle 79A can also deflect in the direction of arrow Z if it encounters forces causing it to deflect in that direction.

After hitting the upper impact grate assembly 31, large coal material and rock 149 then drop and slide downward and onto the lower grizzly 33. Further fines 147 pass through the grizzly 33 while larger coal material and rock 149 continue to slide downward on the grizzly 33 until they reach the lower flail/rotor assembly 23B spinning in the direction of arrow F where they are again struck by this flail/rotor assembly's paddles 79A-B and propelled in the direction of arrow G toward the lower impact grate assembly 35. Upon striking spikes on the lower impact grate assembly 35 and the lower impact grate assembly 35 itself the larger coal material 149 further shatters and breaks apart and passes through the lower impact grate assembly 35 as more fines material 147. Notice that first fines feed chute 29 prevents fines material 147 falling from the upper scalping grizzly 25 from being hit by the lower flail/rotor assembly 23B.

Fines 147 and larger coal and rock 149 that do not make it through the lower impact grate assembly 35 fall downward to reach the lower grates 37A-B where the fines 147 pass through and the larger coal and rock 149 slides downward and onto output chute 41 where it slides out of the coal breaker and sorter 1 so that it can be further processed or disposed of. Fines passing through lower grates 37A-B and passing downward through the back side 7C of the coal breaker and sorter 1 pass through lower final grate 39 and onto the conveyer belt 43 so that these fines can by stockpiled and/or further processed.

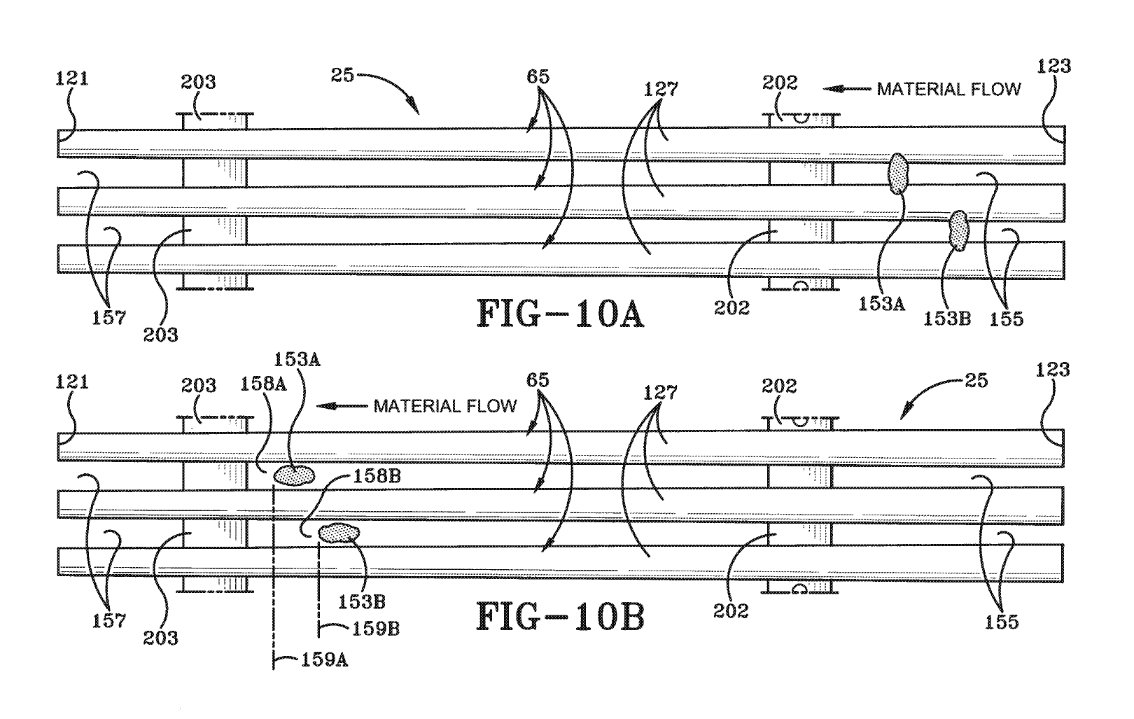

FIGS. 10A-B illustrate how the upper grizzly 25 processes material (i.e., coal). As illustrated in FIG. 10A, two pieces of material 153A-B have reached the grizzly 25. Because the grizzly 25 is installed in the coal breaker and sorter 1 with a downward slope, the material 153A-B begins to slide downward from the right or upper end 123 toward the left or lower end 121 of the grizzly 25. Because the grizzly bars 65 are tapered, narrow gaps between grizzly bars 65 at the right side 123 are narrower than large gaps at the left side 121. In the example embodiment the narrow gaps 155 linearly get wider while traveling from right 123 to left 121 along two adjacent grizzly bars 65. Therefore, as the material 153A-B slides down the grizzly 25 they may eventually reach positions 159A-B (FIG. 10B) where the gaps 158A-B between adjacent grizzly bars 65 are wide enough to let the pieces of material 153A-B respectively fall through the grizzly 25 at respective positions 159A-B as illustrated. Additionally, because the top surface of the grizzly bars 65 is rounded as discussed above, a piece of material 153A-B may additionally rotate or orientate itself in a way that it may fall through a gap sooner than if it didn't orientate itself. Notice in FIGS. 10A-B that both the illustrated materials 153A-B have rotated about 90 degrees from a position they were in when they came into contact with the grizzly 25 until when they fell through the grizzly 25.

FIGS. 11A-C illustrate another way a piece of material (i.e., coal) 161 can pass through a grizzly. FIG. 11A illustrates a piece of material 161 traveling in the direction of arrow G and headed between two adjacent grizzly bars 65. As illustrated in FIG. 11B upon impact with the two grizzly bars 65, the piece of material 161 is partially shattered/broken by sharp edges of 163A-B of the two adjacent grizzly bars 65 so that fragments/shattered particles 165 are broken away from the material 161. As illustrated in FIG. 11C the material 161 and its fragments 165 now pass through the grizzly.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the example embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the example embodiment” or “in the example embodiment” does not necessarily refer to the same embodiment, though it may.

1. An aggregate breaker and sorter comprising:
a housing;
an inclined grizzly assembly inside the housing to allow material of a certain size to pass through the grizzly assembly;
wherein the grizzly assembly further comprises:
a plurality of elongated spaced grizzly bars having upper and lower ends forming tapered openings between adjacent grizzly bars, with said openings being wider at the lower ends than at the upper ends;
a flail assembly with a plurality of paddles inside the housing for moving and accelerating the material as it moves along the grizzly assembly;
an impact grate assembly inside the housing to receive and break material moved by the flail assembly; and
at least one lower grate to allow material of a predetermined size to pass through the at least one lower grate to be transported to a wanted material location, and wherein the at least one lower grate does not allow material larger than the predetermined size to pass through the least one lower grate so that this material can be discarded.

2. An aggregate breaker and sorter as defined in claim 1 wherein the grizzly bars are tapered being wider at the upper ends than at the lower ends to form the tapered openings therebetween.

3. The aggregate breaker and sorter as defined in claim 1 wherein certain of the grizzly bars each have a top surface, a pair of side surfaces, and a bottom surface.

4. The aggregate breaker and sorter as defined in claim 3 wherein the top surfaces of the certain grizzly bars are rounded and the side surfaces are tapered downwardly inwardly from the top surface toward the bottom surface.

5. The aggregate breaker and sorter as defined in claim 4 wherein the top surfaces are rounded convexly and the side surfaces are planar.

6. The aggregate breaker and sorter as defined in claim 5 wherein an angle is formed between the planar side surfaces of the grizzly bars; and in which the angle is between 3° and 40°.

7. The aggregate breaker and sorter as defined in claim 1 further comprising:
an adjustment mechanism to change the incline of the grizzly assembly.

8. The aggregate breaker and sorter as defined in claim 7 wherein the adjustment mechanism further comprises:
a threaded rod adapted to move one of the ends of the grizzly assembly when the threaded rod is rotated.

9. The aggregate breaker and sorter as defined in claim 8 wherein the threaded rod is mounted near the lower end of the grizzly assembly and the upper end is pivotally mounted above the lower end; and wherein the adjustment mechanism is adapted to raise and lower the lower end.

10. The aggregate breaker and sorter as defined in claim 1 including a flair assembly comprising:
a rotatable shaft;
at least two independent paddles operatively mounted on the shaft for hitting aggregate moving through the housing when the shaft is rotating; and
a flexible mounting assembly connecting the said two independent paddles to the shaft providing flexibility of movement independently between the paddles and shaft and independently between said paddles and for positioning the two paddles adjacent and co-planar to each other due to centrifugal force when the shaft is rotating.

11. The aggregate breaker and sorter as defined in claim 10 wherein the flexible mounting assembly includes chains connecting the at least two paddles to the shaft.

12. The aggregate breaker and sorter as defined in claim 11 wherein each of the paddles is connected to the shaft by a pair of chains located generally adjacent outer ends of each paddle.

13. The aggregate breaker and sorter as defined in claim 11 wherein three pairs of adjacent co-planar paddles are spaced 120° apart and attached to the shaft by flexible mounting assemblies.

14. A grizzly assembly for mounting in an aggregate breaker and sorter comprising:
a plurality of elongated grizzly bars having first and second ends forming elongated tapered openings between adjacent grizzly bars, with said openings being smaller at the first end than at the second end.

15. The grizzly assembly defined in claim 14 wherein the grizzly bars are longitudinally tapered being wider at the first ends then at the second ends.

16. The grizzly assembly defined in claim 15 wherein longitudinal centerlines of the grizzly bars are parallel to each other.

17. The grizzly assembly defined in claim 14 wherein certain of the grizzly bars have top surfaces, a pair of side surfaces, and a bottom surface.

18. The grizzly assembly defined in claim 17 wherein the top surfaces of the certain grizzly bars are rounded and the side surfaces are tapered downwardly inwardly from the top surface toward the bottom surface.

19. The grizzly assembly defined in claim 18 wherein the top surfaces are rounded convexly and the side surfaces are planar.

20. The grizzly assembly defined in claim 19 wherein an angle is formed between the planar side surfaces of the grizzly bars; and in which the angle is between 3° and 40°.
